(19) United States
(12) Patent Application Publication
(10) Pub. No.: US 2017/0321924 A1
(43) Pub. Date: Nov. 9, 2017

(54) SMOKE VENT

(71) Applicant: Nystrom, Inc., Brooklyn Park, MN (US)

(72) Inventors: Ian M. Taylor, Eagan, MN (US); Steven G. Stepp, North Branch, MN (US)

(21) Appl. No.: 15/587,478

(22) Filed: May 5, 2017

Related U.S. Application Data
(60) Provisional application No. 62/332,190, filed on May 5, 2016.

(51) Int. Cl. F24F 11/00; E04D 13/03; E04D 13/035; F24F 7/02

(52) U.S. Cl. CPC F24F 11/0086; E04D 13/0352; F24F 7/02; E04D 13/0325; E05Y 2201/11; E05Y 2900/152; F24F 2011/0097; E05Y 2201/244

(57) ABSTRACT

A smoke vent including a curb and door assembly utilizing a continuous hinge assembly that extends an entire length of a door. Hinge members of the door assembly and curb define continuous, extruded hinge members such that the door is supported across the entire length of the hinge members, whereby localized deflection of the curb is avoided. By supporting the door across the entire length of the hinge member, a door seal can be evenly compressed against the curb so as to prevent moisture/water intrusion when the door is in a closed disposition. The door assembly can further include a dome member that substantially defines an upper and lower surface of the door(s). Each door can comprise a plurality of retainer clips that positively couple the dome member to extruded members that define a door frame while providing a moisture resistant seal between the dome member and the door frame.

### RELATED APPLICATION

The present application claims the benefit of U.S. Provisional Application No. 62/332,190 filed May 5, 2016, which is hereby incorporated herein in its entirety by reference.

### FIELD OF THE INVENTION

The present invention is generally directed to roof mounted smoke vents. More specifically, the present invention is directed to a roof mounted smoke vent having an improved curb and door design to simplify manufacturing and installation.

### BACKGROUND OF THE INVENTION

Building codes for large buildings, for example warehouses and factories generally require the installation of one or more smoke vents on the roof. In the event of a fire emergency, one or more doors on the smoke vent are opened, either automatically or at the direction of emergency personnel, to release heat, smoke and or noxious fumes from an interior of the building. Generally, opening of the door(s) is accomplished through activation of a heat trigger or alternatively, using a manual release that is located on an exterior of the smoke vent.

In order to successfully open the door(s), the door(s) must be hinged to an exterior curb of the smoke vent. The exterior curb mounts to the roof and projects upward from the roof surface. Generally, two or more hinges are mounted to the exterior curb whereby the hinges are attached to the door(s) so as to allow the doors to rotate between a closed/covering disposition and an open/venting disposition. Due to the size and weight of the doors, these hinges generally must be of a heavy duty design and require various operations including, for example, drilling, welding, fastening and the like to properly install the doors. Furthermore, due to the weight of the doors, the amount of localized torque at each hinge can cause localized deflection of the exterior curb which can lead to sealing issues and potential moisture leakage.

In view of the costs and potential mounting issues associated with conventional hinged smoke vents, it would be advantageous to improve upon current designs.

### SUMMARY OF THE INVENTION

The present invention is generally directed to a smoke vent including a curb and door assembly utilizing a continuous hinge assembly that extends an entire length of a door. Generally, the continuous hinge assembly can comprise a pair of corresponding hinge members that are rotationally engageable across a rotation range of between 0 and 90 degrees, measured in relation to a door position relative to the curb. Beyond 100 degrees, the door can be lifted into position relative to the curb and subsequently rotated to an orientation less than 100 degrees, whereby the door is positively, hingedly connected to the curb. The corresponding hinge members of the door assembly and curb can comprise continuous, extruded hinge members such that the door is supported across the entire length of the hinge members, whereby localized deflection of the curb is avoided. By supporting the door across the entire length of the hinge member, a door seal can be evenly compressed against the curb so as to prevent moisture/water intrusion when the door is in a closed disposition. In some representative embodiments, the door(s) can further comprise a polymeric dome member that substantially defines an upper and lower surface of the door(s). Each door can comprise a plurality of retainer clips that positively couple the dome member to the door while providing a moisture resistant seal between the polymeric dome member and a door frame.

In one aspect of the present invention, a smoke vent can comprise a curb member and one or more door assemblies, wherein a hinge assembly for mounting the door assemblies to the curb member is integrally formed into the curb member and door assembly. Generally, the curb member can include a hinge wall side including a continuous hinge mount that is continuously defined along en entire length of the hinge wall. The continuous hinge mount can include a projecting member having an arcuate hinge surface. Each door assembly can include a door frame formed of an extruded assembly about the perimeter of the door frame. The extruded assembly can include a lower hinge engagement portion including a hinge tab having an arcuate hinge channel. The door assembly can be positioned so as to engage the arcuate hinge surface with the arcuate hinge channel whereby the door assemblies can be rotated between open and closed positions relative to the curb member. In some embodiments, the lower hinge engagement portion can include a projecting drip edge extending below and out from the continuous hinge mount to assist in preventing moisture intrusion into the smoke vent.

In yet another aspect, a door assembly can comprise a door frame, a cover panel and a plurality of panel retainer clips. The door frame can be formed by coupling a plurality of extruded assemblies that form each side of the door frame. The cover panel can then be positioned above an upper engagement surface on each of the extruded assemblies. Along each side, a panel retainer clip can be positioned over the cover panel and then snapped into position relative to the extruded assembly with a latching member on the panel retainer clip positively engaging a receiving channel on the extruded assembly. In this manner, the door assembly can be fabricated with a minimum of fasteners and fastener operations to reduce both material and labor costs. In some embodiments, a

In yet another aspect, the present invention is directed to methods of fabricating a smoke vent assembly.

In another aspect, the present invention is directed to methods of assembly for a smoke vent door assembly.

In another aspect, the present invention is directed to a reduced cost smoke vent assembly in which forming operations, fasteners and labor costs are reduced through the use of extruded assemblies to form a curb member and door frame.

In yet another aspect, the present invention is directed to a reduced cost roof hatch assembly in which forming operations, fasteners and labor costs are reduced through the use of extruded assemblies to form a curb member and door frame.

In still another aspect, the present invention can be directed to a detachable hinge mount that allows the benefits of a continuous hinge to be added or retrofitted to conventional or existing curb walls.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which: FIG. 1 is a top perspective view of a smoke vent according to a representative embodiment of the present invention.

FIG. 2 is a section view taken at line 2-2 of FIG. 1.

FIG. 3 is a detailed section view of a hinge mount wall of the smoke vent of FIG. 1 in a fully closed position.

FIG. 4 is a detailed section view of a hinge mount wall of the smoke vent of FIG. 1 in an open position.

FIG. 5 is an exploded section view of a door frame according to a representative embodiment of the present invention.

FIG. 6 is a section view of the door frame of FIG. 6.

FIG. 7 is a section view of a door frame and hinge mount wall with a cover portion removed according to a representative embodiment of the present invention.

FIG. 8 is an exploded section view of a door frame according to another representative embodiment of the present invention.

FIG. 9 is a section view of a detachable hinge mount according to a representative embodiment of the present invention.

FIG. 10 is an exploded section view of a hinge mount wall using the detachable hinge mount of FIG. 9.

FIG. 11 is a section view of the hinge mount wall of FIG. 10.

FIG. 12 is a side view of a hinge mount wall including the detachable hinge mount of FIG. 9.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

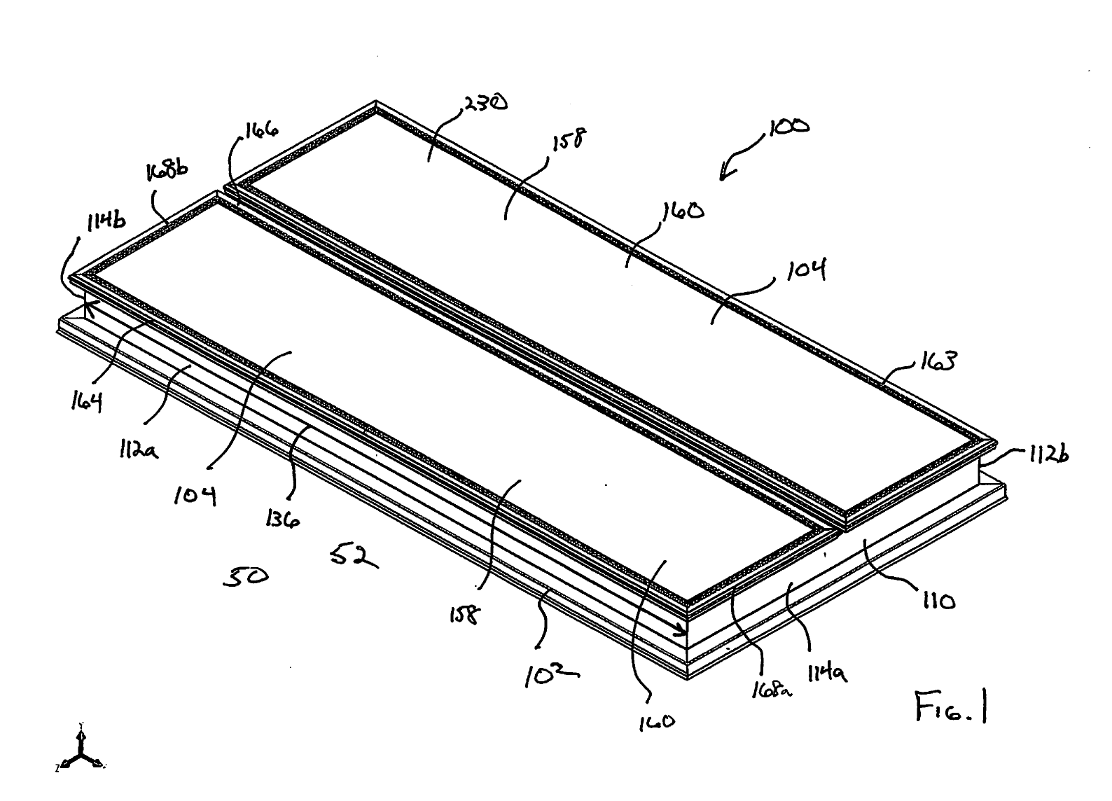

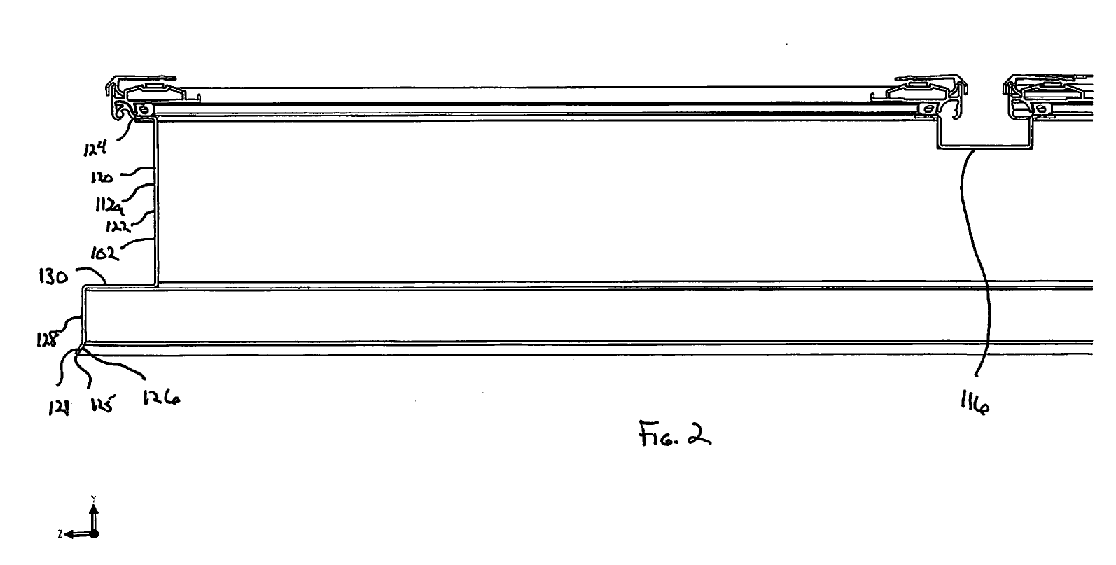

As shown in FIG. 1, a smoke vent 100 according to the present invention is mounted directly to a roof 52 of a building 50, for example, a warehouse or factory. Generally, smoke vent 100 comprises a curb member 102 and one or more door assemblies 104. Depending on the size and application, smoke vent 100 can include a pair of door assemblies 104 as shown in FIGS. 1 and 2 or alternatively, smoke vent 100 can comprise a single door assembly. In the case of a smoke vent 100 utilizing a pair of door assemblies 104, it will be understood that each door assembly 104 is essentially equivalent in design and components with the exception of a reversed mounting arrangement. Though not illustrated, it will also be understood that smoke vent 100 includes the necessary safety components including a latch assembly, latch release and lifting members to allow for the door assemblies 104 to open in the event of an emergency or as dictated by emergency or maintenance personnel. Furthermore, it will be understood to one or ordinary skill that the concepts disclosed with respect to the construction of smoke vent 100 can be similarly applied to other roof accessories, including for example, root hatches.

Generally, curb member 102 is formed of a moisture resistant metal or alloy such as, for example, aluminum. Curb member 102 generally defines a square or rectangular curb perimeter 110. Curb member 102 comprises a pair of opposed hinge mount walls 112a, 112b, a pair of end walls 114a, 114b and a gutter member 116. Generally, the hinge mount walls 112, end walls 114a, 114b and gutter member 116 all comprise individually extruded members that are welded together to define the curb member 102. Hinge mount walls 112a and 112b are essentially the same member except for being oriented in the opposite direction. End walls 114a and 114b are also essentially the same member except for being oriented in opposite directions when coupled together to form the curb member 102. Curb member 102 is generally mounted between the end walls 114a, 114b at a midpoint position between the hinge mount walls 112a, 112b.

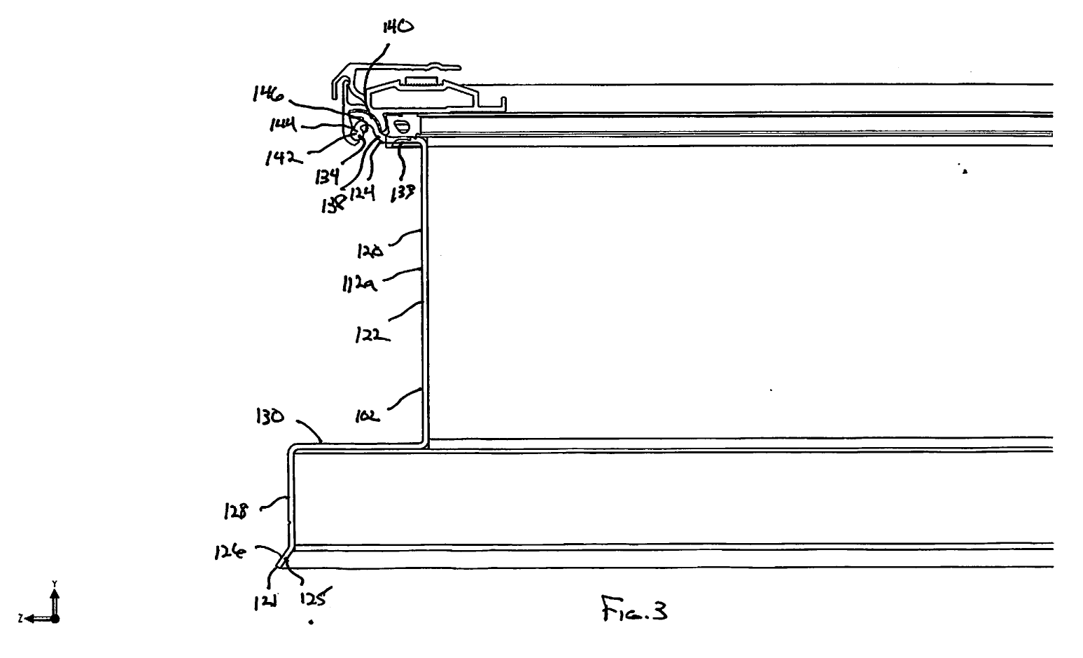

As seen in FIGS. 2, 3 and 4, the curb member 102, and more specifically the opposed hinge mount walls 112a, 112b and end walls 114a, 114b generally define a curb wall 120 having a roof mounting end 121, an upwardly projecting wall 122 and an upper end 124. Roof mounting end 121 can comprise any of a variety of configurations depending upon roof design without departing from the spirit and scope of the present invention. For example, roof mounting end 121 can comprise an apron mount style 125 to allow for connection to an apron flange (not shown) that projects upward from a roof. Apron mount style 125 can comprise an angled surface 126, a projecting surface 128 and an apron flange 130.

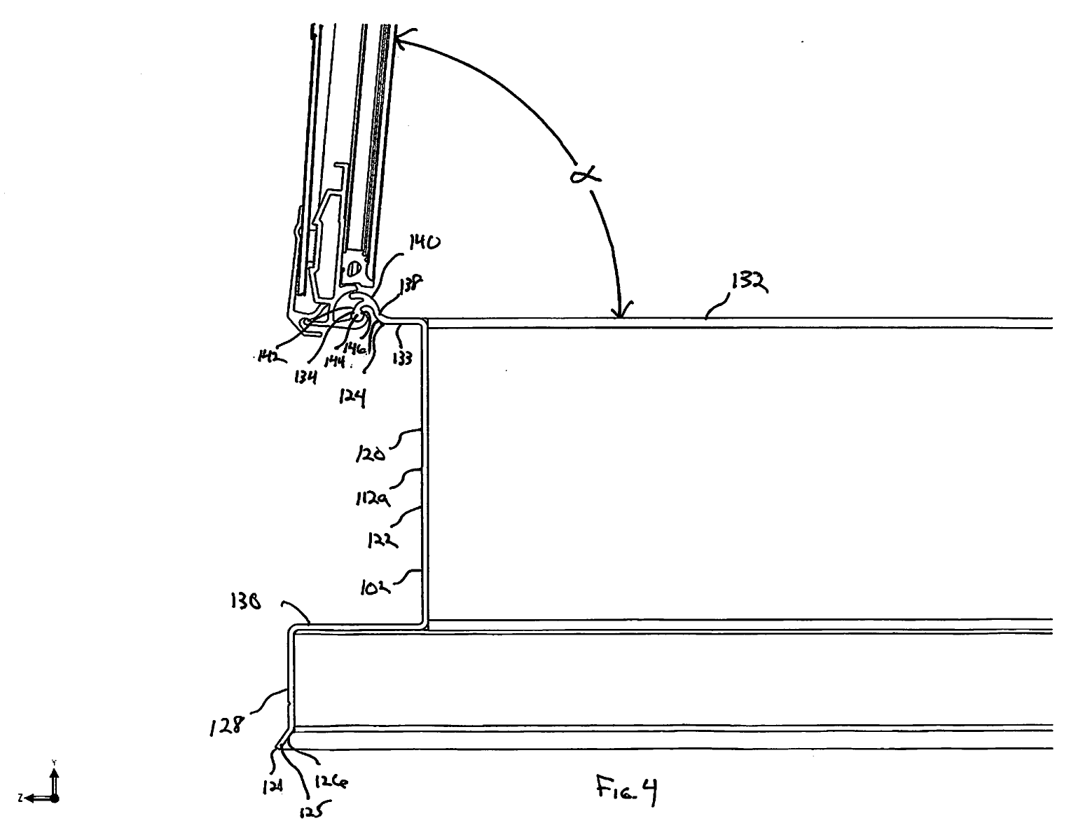

The design of upper end 124 varies between the opposed hinge mount walls 112a, 112b and the end walls 114a, 114b. For end walls 114a, 114b, the upper end 124 terminates in a sealing flange 132 as shown in FIG. 4. For hinge mount walls 112a, 112b, the upper end 124 defines a hinge flange 133 and a continuous hinge mount 134 as seen in FIGS. 2, 3 and 4. The continuous hinge mount 134 is continuously defined along an entire hinge wall length 136 of the hinge mount walls 112a, 112b as shown in FIG. 1. Continuous hinge mount 134 comprises a lateral surface 138, an upper arcuate surface 140 and a downwardly projecting hinge member 142. Downwardly projecting hinge member 142 has a generally circular hinge cross-section 144 defining an arcuate hinge surface 146.

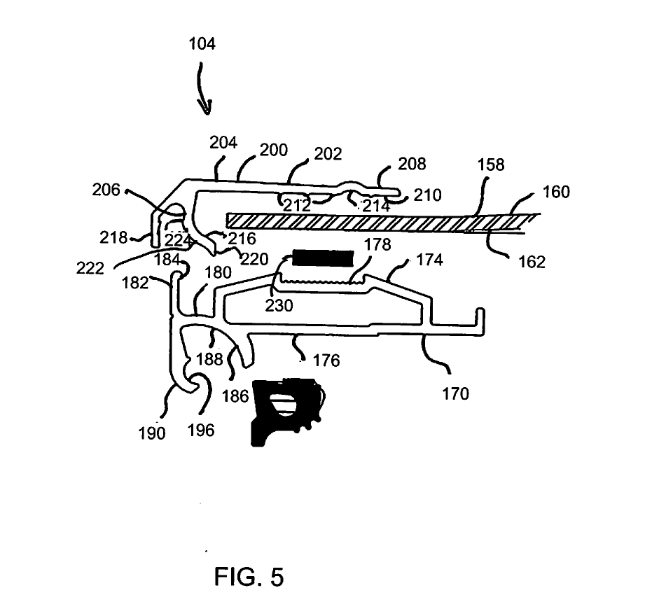

Door assembly 104 generally comprises a cover panel 158 defining an upper exterior surface 160 and a lower interior surface 162 as shown in FIGS. 1 and 5. Cover panel 158 can comprise a flat or generally flat panel or alternatively, a domed or double domed design. Door assembly further includes a door frame 163 having a hinge side 164, a latch side 166 and a pair of opposed end sides 168a, 168b. The door frame 163, and more specifically, the hinge side 164, the latch side 166 and the opposed end sides 168a, 168b are each generally defined by an extruded assembly 170 that forms the entire length of each side of the door frame 163. Extruded assembly 170 serves to perform a hinge function along the hinge side 164 but also serves to couple the cover panel 158 to the door assembly 104 on each of the hinge side 164, the latch side 166 and the pair of opposed end sides 168a, 168b. Extruded assembly 170 generally defines an upper dome engagement surface 174 and a lower hinge engagement portion 176. Upper dome engagement surface 174 includes a serrated seal surface 178, a receiving channel 180 and a projecting tab 182 having a tab lip 184. Lower hinge engagement portion 176 includes a lower arcuate surface 186 having an arcuate profile 188 that matches and corresponds to the upper arcuate surface 140. Lower hinge engagement portion 176 further includes a hinge tab 190 including an arcuate hinge channel 196. Lower hinge engagement portion 176 is generally only utilized along the hinge side 164 but is present and unused along the latch side 166 and the opposed end sides 168a, 168b.

Door assembly 104 further comprises a panel retainer clip 200 as shown in FIG. 5. Panel retainer clip 200 generally comprises an extruded retainer body 202 including a retainer portion 204 and a latching portion 206. Retainer portion 204 generally defines an upper surface 208 and a lower surface 210. Lower surface 210 includes a plurality of downward barbs 212 and a seal channel 214. Latching portion 206 comprises a latch member 216 and a biasing member 218. Latching member 216 includes an engagement face 220 and a latching surface 222. Latching surface 222 includes a latch recess 224.

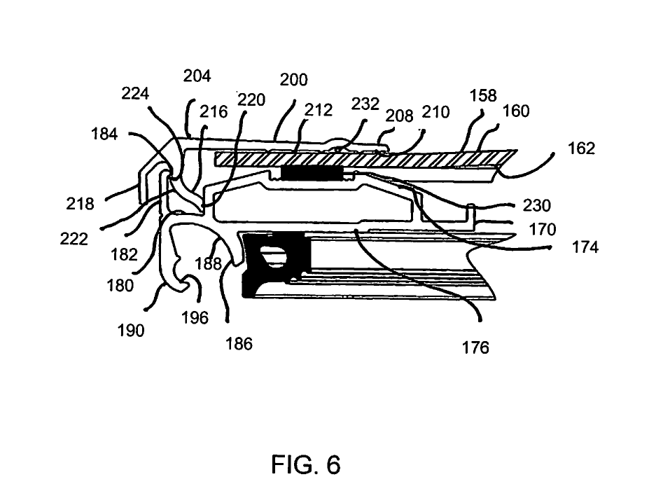

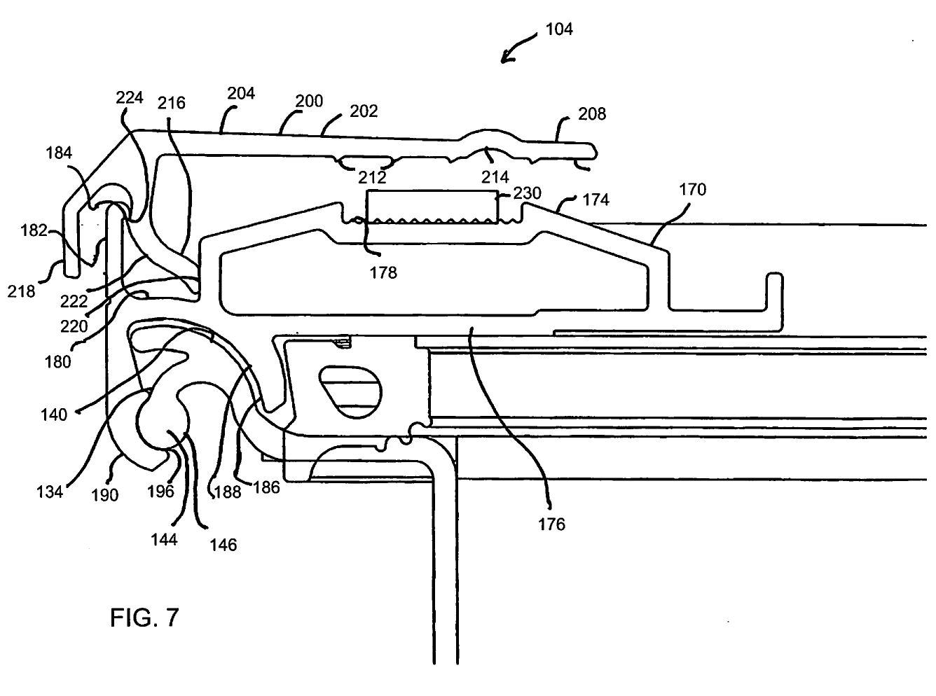

In assembling door assembly 104 as shown in FIG. 6, a seal member 230 is positioned on the serrated seal surface 178 on each extruded assembly 170 along the entire length of the hinge side 164, the latch side 166 and the opposed end sides 168a, 168b. Next, the cover panel 158 is placed so as to rest on top of the seal member 230 that is present on each of the hinge side 164, the latch side 166 and the opposed end sides 168a, 168b. A clip seal member 232, for example liquid silicone, can be applied within the seal channel 214. The panel retainer clip 200 is then positioned such that the latching portion 206 is positioned proximate the receiving channel 180. The latching portion 206 is inserted into the receiving channel 180 such that the engagement face 220 contacts the receiving channel 180 with the latching surface 220 becoming captured and retained by the by the tab lip 184 of the projecting tab 182. This locks the panel retainer clip 200 to the extruded assembly 170 with the cover panel 158 captured between the upper dome engagement surface 174 and the lower surface 210 of the retainer portion 204. The process of coupling the panel retainer clip 200 to the extruded assembly 170 for capturing the cover panel 158 is the same and is repeated for each of the hinge side 164, the latch side 166 and the pair of opposed end sides 168a, 168b to define the door frame 163.

Once door assembly 104 is assembled, door assembly 104 can be positioned above the curb member 102 with the hinge side 164 positioned proximate hinge mount wall 112a. In order to hingedly attach the door assembly 104 to the curb member 102, door assembly 104 should be positioned such that the hinge tab 190 is positioned below the projecting hinge member 142. The door assembly 104 is then manipulated to bring the arcuate hinge channel 196 into contact with the arcuate hinge surface 146. With the hinge tab 190 and the projecting hinge member 142 engaged, the door assembly 104 can begin to rotate about the projecting hinge member 142 whereby the arcuate profile 188 of the lower arcuate surface 186 begins to interface with the upper arcuate surface 140. The door assembly 104 can then be rotated to a fully closed position 230 as shown in FIG. 1. Because of the interaction of the hinge tab 190 and the projecting hinge member 142 as well as the engagement of the lower arcuate surface 186 and the upper arcuate surface 140, the door assembly 104 remains coupled to the curb member 102 as the door assembly is rotated to an open position 232 as shown in FIG. 4. More specifically, the door assembly 104 remains positively coupled to the curb member 102 across a rotation angle α of 0 degree (closed position 230) all the way to a rotation angle α of 90 degrees (open position 232). Only after the door assembly is rotated past a rotation angle α of approximately 100 degrees, dictated by the engagement of the lower arcuate surface 186 and the upper arcuate surface 140, is the door assembly 104 capable of being removed from the curb member 102.

As the hinge tab 190 and projecting hinge member 142 extend the entire length of the extruded assembly 170 and the hinge mount wall 112a respectively, the hinge engagement is continuous along the entire length of the hinge side 164. As such, there is no localized deflection at specific hinge locations as found in typical designs, and instead, even pressure is applied to the hinge flange 133 and against a curb seal 240.

With the present design, manufacturing and assembly of the smoke vent 100 is simplified and costs are reduced through the use of extrusion techniques and by removing the number of fastener and welding operations necessary to fabricate the smoke vent 100. For example, extruded assembly 170 is used on each side of the door frame 163. In addition, cover panel 158 is coupled to the door frame 163 using a single, full length panel retainer clip along each side of the door frame 163 so as to remove the necessity for multiple fasteners. In addition, by extruding the projecting hinge member 142 as part of the hinge mount walls 112a, 112b and the hinge tab 190 as part of the extruded assembly 170, no separate hinge parts are required to be purchased nor are they required to be separately installed on the curb member 102 and the door frame 163. The use of the disclosed extruded assemblies can be applied across other roof components including, for example, roof hatches.

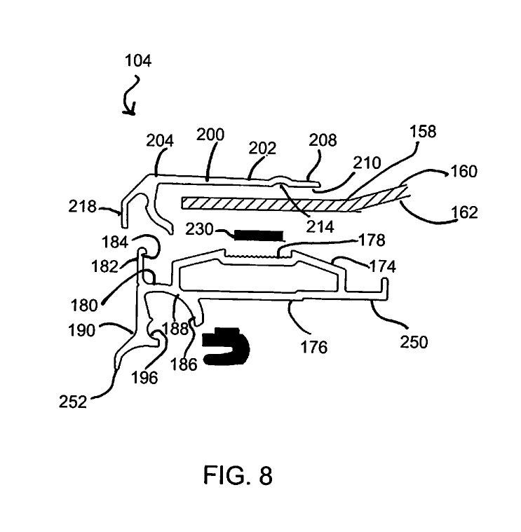

With reference to FIG. 8, additional features can be incorporated into extruded assembly 170 to form an extruded assembly 250 that similarly engages with the panel retainer clip 200 in assembling the door assembly 104 as well as rotating about the projecting hinge member 142. As shown in FIG. 8, the lower hinge engagement portion 176 and more specifically, the hinge tab 190 can further comprise a projecting drip edge 252 that extends outward from and below the arcuate hinge channel 196. In this way, projecting drip edge 252 adds additional protection from moisture intrusion into the curb member 102

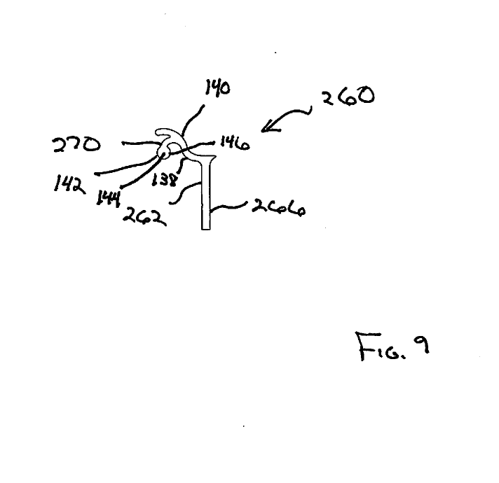

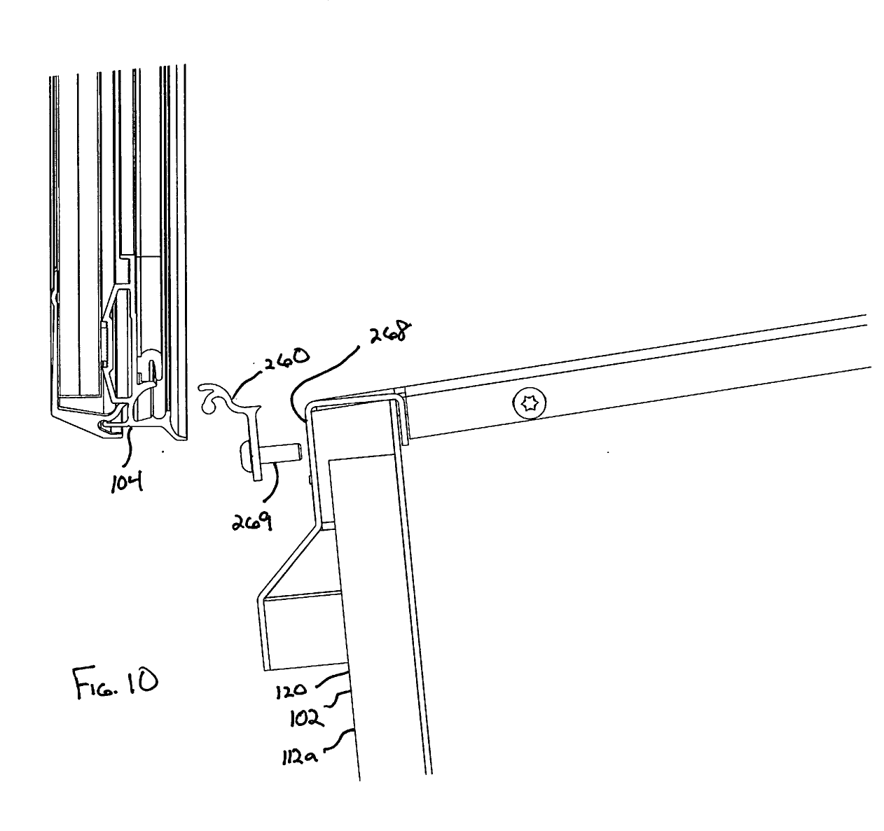

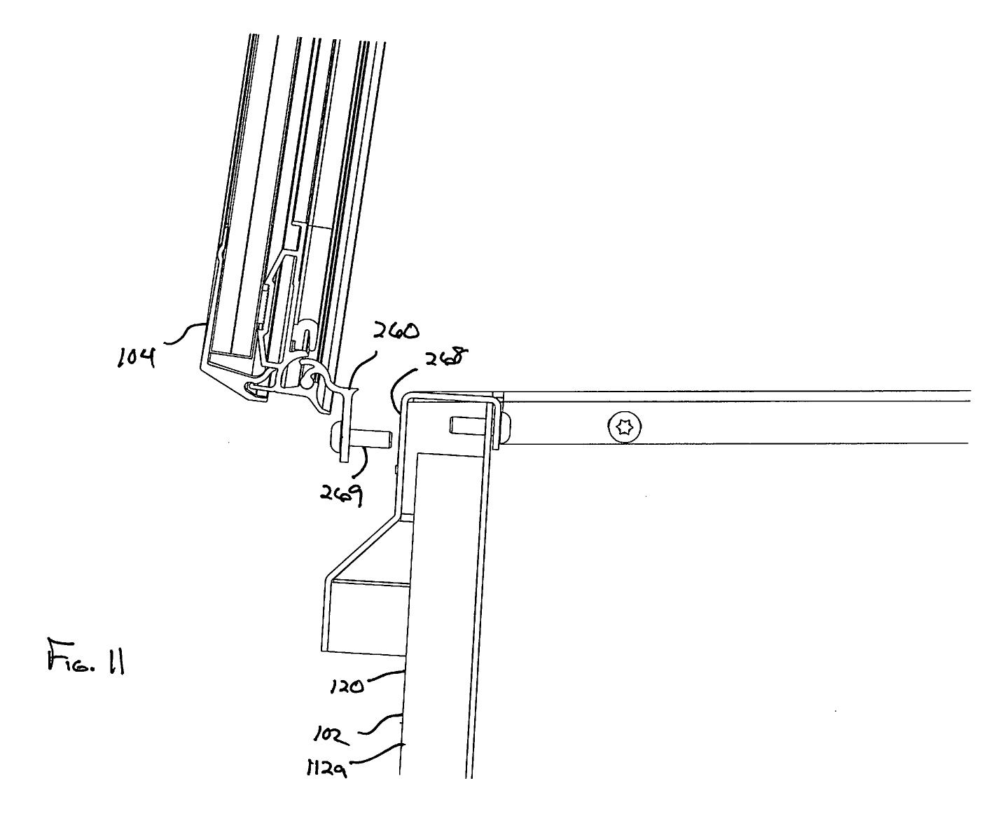

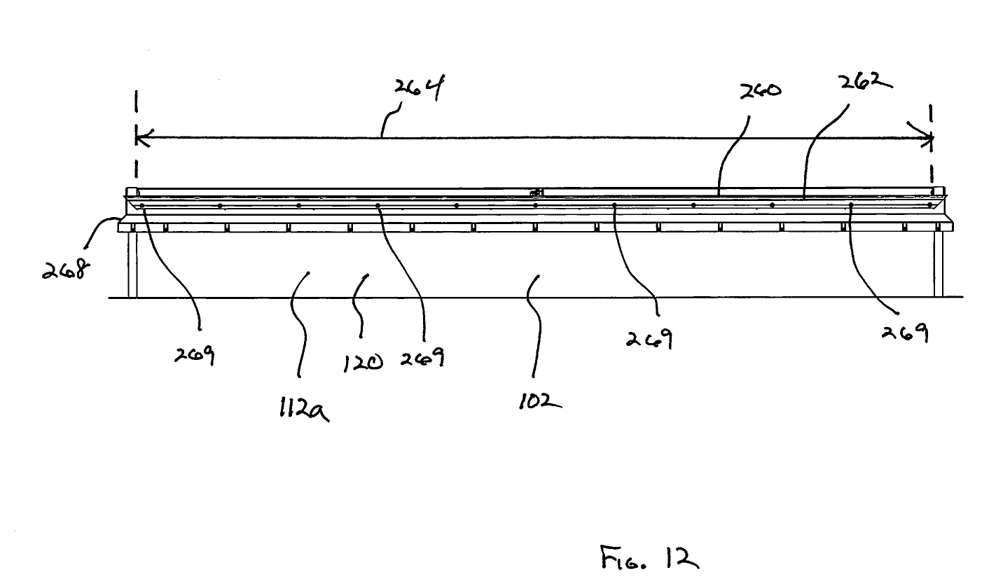

Finally, in an alternative embodiment as shown in FIGS. 9-12, the advantages of the continuous hinge engagement and the assembly techniques for door assembly 104 can be added or retrofitted to existing designs and installed curb members 102 through the use of a detachable hinge mount 260. Generally, detachable hinge mount 260 can couple to an existing curb member 102 so as to impart similar functionality and structure to the curb member 102 as is provided by continuous hinge mount 134. Detachable hinge mount 260 generally comprises a body member 262 having a mount length 264 that is equal to the length of the hinge mount wall 112a. Body member 262 includes a mount surface 266 that can be placed directly against the curb wall 120 or against curb flashing 268 as shown in FIGS. 10-12. Generally, a plurality of fasteners 269 can be utilized for coupling the mount surface 266 to the curb wall 120/curb flashing 268. Extending from the mount surface 266 is a hinge portion 270 including lateral surface 138, upper arcuate surface 140 and downwardly projecting hinge member 142. Downwardly projecting hinge member 142 has a generally circular hinge cross-section 144 defining an arcuate hinge surface 146. Hinge portion 270 is defined along the full mount length 264 such that the use of door assembly 104 and detachable hinge mount 260 imparts the previously described benefit of continuous hinge engagement as described previously with respect to curb wall 120 that includes the continuous hinge mount 134 as part of an integral, extruded assembly.

While the invention is amenable to various modifications and alternative forms, specifics thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims. Furthermore, while the present application has been described with respect to a smoke vent, the principles associated with the continuous extruded hinge as well as the use of a panel retainer clip in door assembly can be similarly applied to other roof components including, for example, roof access hatches and the like.

1. A smoke vent, comprising:
a curb member having a hinge mount wall, the hinge mount wall including a hinge member continuously defined along a wall length of the hinge mount wall; and
a door assembly including a hinge side, the hinge side having a hinge tab defining an arcuate hinge channel, wherein the hinge tab is continuously defined along a hinge side length of the hinge side,
wherein the arcuate hinge channel engages the hinge member continuously along the entire hinge side.

2. The smoke vent of claim 2, wherein the hinge member is formed integrally with the hinge mount wall.

3. The smoke vent of claim 1, wherein the hinge member is detachably coupled to the hinge mount wall.

4. The smoke vent of claim 1, wherein the hinge tab is defined on an extruded assembly including a lower hinge engagement portion and an upper dome engagement surface.

5. The smoke vent of claim 4, wherein the lower hinge engagement portion includes a projecting drip edge extending below the arcuate hinge channel and outwardly away from the hinge mount wall.

6. The smoke vent of claim 4, wherein the door assembly further comprises:
a panel retainer clip; and
a cover panel,
wherein the cover panel is sealably captured between the upper dome engagement surface and a lower surface of the panel retainer clip.

7. The smoke vent of claim 6, wherein the panel retainer clip includes a latching portion having a latch member and a biasing member, and wherein the upper dome engagement surface defines a receiving channel such that said receiving channel retainably receives the latch member, whereby the cover panel is captured between the upper dome engagement surface and the lower surface.

8. The smoke vent of claim 1, wherein the arcuate hinge channel continuously engages the hinge member between an angular range of 0 degrees to about 100 degrees as measured from a sealing flange on the curb member.

9. The smoke vent of claim 8, wherein the door assembly can be selectively attached to or detached from the curb member when the orientation of the door assembly to the sealing flange exceeds the angular range.

10. The smoke vent of claim 1, further comprising:
a second hinge mount wall located opposite the hinge mount wall, the second hinge mount wall including a second hinge member continuously defined along the wall length of the second hinge mount wall; and
a second door including a second hinge side, the second hinge side having a second hinge tab defining a second arcuate hinge channel, wherein the second hinge tab is continuously defined along the hinge side length of the second hinge side,
wherein the second arcuate hinge channel engages the second hinge member continuously along the entire second hinge side.

11. A method for assembling a smoke vent, comprising:
positioning a door assembly having a hinge side such that the hinge side is proximate a hinge mount wall of a curb member;
placing an arcuate hinge channel defined continuously along the hinge side into contact with a hinge member defined continuously along the hinge mount wall; and
rotating the door assembly to a closed position over the curb member whereby the hinge member and the arcuate hinge channel are in continuous contact to define a continuous hinge.

12. The method of claim 11, further comprising:
attaching a detachable hinge mount to the hinge mount wall, wherein the hinge member is defined on the detachable hinge mount.

13. The method of claim 11, wherein the step of positioning the door assembly further comprises:
orienting the door assembly such that the door assembly and a sealing flange on the curb member define an angle exceeding 100 degrees.

14. The method of claim 11, further comprising:
rotating the door assembly to an open position over the curb member wherein the door assembly and a sealing flange on the curb member define an angle of 100 degrees or less.

15. A smoke vent hinge assembly, comprising:
a hinge member defined continuously along a hinge mount wall of a curb member; and
an arcuate hinge channel defined continuously along a hinge side of a door assembly,
wherein the hinge member and the arcuate hinge channel define a hinge assembly and the hinge member and the arcuate hinge channel are in continuous contact along a length of the hinge assembly.

16. The smoke vent hinge assembly of claim 15,
wherein the arcuate hinge channel can be placed into contact with the hinge member when the door assembly is oriented relative to a curb member at an angle exceeding 100 degrees.

17. The smoke vent hinge assembly of claim 15, wherein the door assembly remains retainably attached to the curb member when the door assembly is oriented relative to a curb member at an angle of 100 degrees or less.

18. The smoke vent hinge assembly of claim 15, wherein the hinge member is defined on a detachable hinge mount and wherein the detachable hinge mount is removably coupled to the curb member.

19. The smoke vent hinge assembly of claim 15, wherein the hinge side of the door assembly includes a projecting drip edge extending below the arcuate hinge channel and outwardly away from the hinge mount wall.
